(19) United States
(12) Patent Application Publication
(10) Pub. No.: US 2009/0138612 A1
(43) Pub. Date: May 28, 2009

(54) Control device

(75) Inventor: Sven Grinder, Lage (DE)

Correspondence Address: DeMont & Breyer, LLC, 100 Commons Way, Ste. 250, Holmdel, NJ, 07733, US

(73) Assignee: PHOENIX CONTACT GMBH & CO. KG, Blomberg (DE)

(21) Appl. No.: 12/260,316

(22) Filed: Oct. 29, 2008

(30) Foreign Application Priority Data
Nov. 22, 2007 (DE) 10 2007 056 496.3

(51) Int. Cl. G06F 15/16

(52) U.S. Cl. 709/230

(57) ABSTRACT

The present invention relates to a control device with a supply device (101) for preparing control data for process control and with a network device (103) for transmitting or receiving control data using the Simple Network Management Protocol.

The present invention relates to a control device.

For controlling technical processes, such as, for example, computer programs running on electronic devices, controllers can be used that perform the control on the basis of control parameters or process parameters that can be transmitted by means of an Ethernet network connection.

Known Ethernet components, such as, for example, PCs (Personal Computers), printers, bus couplers, controllers, or switches are often made available via agents (servers) that perform communications using the Simple Network Management Protocol (SNMP). The Simple Network Management Protocol is used in networks for managing the different network subscribers and offers a standardized way to exchange data, wherein this protocol defines only the type and method of access. The network can be monitored from a central station, for example, from a PC with corresponding management software. For this purpose, SNMP queries are sent to the subscribers, in order to request data such as, for example, information on component load or an error counter. Based on the reported data, a network can be monitored, so that disruptions can be recognized in a timely manner. In addition, the network subscribers can also be accessed in a controlled way via the SNMP.

Known SNMP agents are in the position to send a message (trap), for example, to a management tool (client) based on special events, whereupon the management tool performs further actions, such as reading or writing objects. For communications, the SNMP uses the connectionless UDP/IP (User Datagram Protocol/Internet Protocol) via the ports 161 and 162.

The SNMP can also be used in control systems. Currently, however, for accessing process data, a client can access an OPC server of the respective controller manufacturer only via an OPC protocol (OLE for Process Control) or from there can access the controller via a proprietary protocol. Therefore, for example, a PC program can operate an SNMP-OPC gateway via the SNMP, wherein this gateway is connected to an OPC server that, in turn, accesses the controller via the OPC protocol. This communications concept, however, is inflexible and inefficient.

The task of the invention is to create an efficient design for data communications between control devices.

This task is achieved by the features of the independent claims.

The present invention is based on the knowledge that efficient communications between control devices or between controllers can be performed directly on the basis of the Simple Network Management Protocol. This means that the controllers communicate with each other and exchange data, such as process or control data, directly via the SNMP.

The SNMP can run, for example, as a functional component in a control program, so that access to process data of the controller is possible on the basis of the SNMP, e.g., via an Internet or an Ethernet connection from a central control room. A user can define, for example, a virtual database according to his own requirement criteria and this database can be accessed by means of the freedom according to the invention in the access to the control variables of the control device.

According to one aspect, the invention relates to a control device with a supply device for preparing control data for the process control and a network device for transmitting or receiving the control data using the Simple Network Management Protocol.

According to one embodiment, the supply device is constructed to transmit the control data to the network device or to receive the control data from the network device.

According to one embodiment, the network device comprises a protocol device that is designed with respect to programming to be able to run the Simple Network Management Protocol.

According to one embodiment, the network device comprises a transmitter and/or a receiver for communicating via a communications network, for example, via an Ethernet communications network, using the Simple Network Management Protocol.

According to one embodiment, the control data comprise process data, process parameters, or control parameters.

According to one embodiment, the supply device comprises a memory device for storing the control data in a database.

According to one embodiment, the control device is constructed to communicate with another control device via the communications network using the Simple Network Management Protocol.

According to one embodiment, the control device comprises a server and/or a client for communicating via the communications network using the Simple Network Management Protocol.

According to another aspect, the invention relates to a control system for controlling a control device, wherein the control device is provided for process control using control data. The control system comprises a supply device for preparing the control data and a network device for transmitting the control data to the control device via a communications network using the Simple Network Management Protocol.

According to another aspect, the invention relates to a use of the Simple Network Management Protocol for communicating control data or process data or control parameters or process parameters between control devices via a communications network.

According to another aspect, the invention relates to a control method using control data with preparation of the control data and transmission or reception of the control data using the Simple Network Management Protocol.

According to one embodiment, a technical process is controlled using control data.

According to another aspect, the invention relates to a method for controlling a control device, wherein the control device is provided for process control using control data and wherein the method comprises the preparation of the control data and the transmission of the control data to the control device via a communications network using the Simple Network Management Protocol.

According to another aspect, the invention relates to a program-specific device constructed to be able to run a computer program for executing one of the methods according to the invention.

According to another aspect, the invention relates to a computer program for executing one of the methods according to the invention when the computer program runs on a computer.

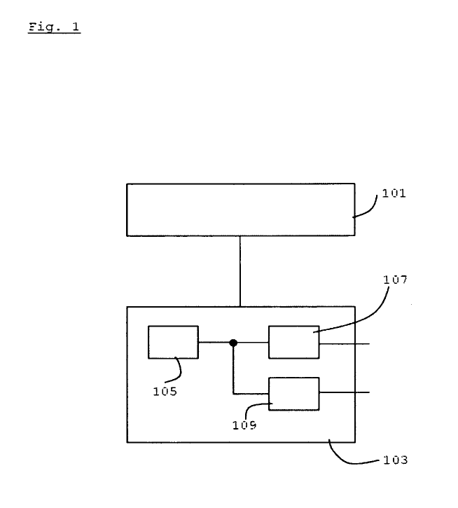

Additional embodiments will be explained with reference to the accompanying FIG. 1 that shows a block diagram of a control device.

The control device comprises a supply device 101 and a network device 103 that are coupled to each other. The supply device 101 provides control or process data for process control, wherein the network device 103 can transmit the control data or receive additional control data using the Simple Network Management Protocol. The control device from FIG. 1 can be further constructed to perform the process control. For this purpose, the control device can further have a control element that can perform the process control using the supplied or received control data.

The network device 103 can further comprise a protocol device 105 that is constructed to be able to execute, through its program-specific device, the Simple Network Management Protocol that can be embedded as a program component within a control program. The illustrated network device 103 further comprises a receiver 107 and a transmitter 109 that can be connected to the protocol device 105 and that are provided to receive or transmit data using the SNMP. The receiver 107 and the transmitter 109 can be constructed, for example, to transmit data wirelessly via UMTS or WLAN (Wireless Local Access Network). In addition, the receiver 107 and the transmitter 109 can be provided to receive or to transmit data using wires via, for example, an Ethernet communications network.

The controller shown in FIG. 1 can communicate directly via SNMP with another controller that can be constructed, for example, like the controller shown in FIG. 1, spanning different manufacturers. Preferably, a corresponding server and/or client functionality not shown in the figure is made available to the controllers. In other words, the controller shown in FIG. 1 can operate as a server and/or as a client. The use of the SNMP allows the use of a standard protocol that can be described and improved, for example, using the so-called Request for Comment (RFC). In addition, the structure of the Management Information Base (MIB) can be defined arbitrarily by the user. Furthermore, the MIB can be converted into a control program as an SNMP client and/or SNMP server.

Preferably, an SNMP server and/or an SNMP client can be made available to an applicant for controllers that can then be used by the user. Here, the user can define the MIB by means of the type and the number of objects and the data accesses to be realized, for example, in a user program (application program). The SNMP agents and clients and also the trap transmitters and receivers can further be designed and offered as functional components.

It is also possible, in addition to the SNMP agents, to realize universal SNMP clients and trap transmitters and/or receivers as components. These components can be assembled into, for example, an SNMP component library.

The concept according to the invention offers the possibility for the user to use completed program parts for his control program, wherein these parts take over the access to the network and the handling of the SNMP. The user can then concentrate on his application and the programming. If there is the desire to exchange data with another controller, with another I/O device, or with a PC program, then the user can use the provided components flexibly and efficiently. It is further left up to the user what data is transmitted. It can be, for example, information from input and output units that can be connected to the controller. Thus, for example, temperature values or switch states can be distributed directly via SNMP without further processing. However, it can also be information from the control program that is calculated or provided by the control program. The data can involve a velocity, a cycle time of the control, a runtime of the controller, the name of the programmer of the control program, or a position of cargo on a transport path.

In addition, the data can be stored in a virtual database, e.g., in the already mentioned Management Information Base (MIB). The data can be described in a text file in Abstract Syntax Notation (ASN1), wherein a data set can be a device name, a time period, a clock time, a counter status, or also a temperature, whereby it is determined which objects exist and how the values are to be interpreted. The MIB is, for example, a database in which the data are organized in the form of a tree structure. Some or all of the nodes and/or branches of the tree or sub-regions of the database can be described in standard MIBs. In the example of a controller, a manufacturer can publish, for example, an MIB that has a text file with the description of the implemented objects. The SNMP communications according to the invention can run according to one embodiment as follows: an SNMP client requests an object at an SNMP agent. The SNMP agent, however, does not necessarily need a database in order to reply to this query. Instead, the SNMP agent can receive the query, extract the information on the requested object, and retrieve the data. In the case of the SNMP agent on the controller side, the agent can then access, for example, a variable of the control program. The reply can be transmitted via the network as an SNMP packet from the SNMP agent to the appropriate client.

According to another embodiment, two or more controllers can operate simultaneously and can be connected to a network. Each controller comprises input and output units, such as, for example, switches or lamps, and regularly reads the input data, processes the values, and writes values onto the outputs. For example, if the controller A requires a value of the controller B or if it would like to intervene in the program sequence of the controller B, then the controller A transmits a query to the controller B using SNMP. The controller B receives the message and processes it, wherein the controller B sends back a requested value from its program or from the runtime environment to the controller A (SNMP Get query) or transfers a value transmitted from the controller A into its program (SNMP Set service) and confirms the receipt.

Furthermore, if special events occur in its program sequence, the controller A can transmit a special message (SNMP Trap) to the controller B. However, any SNMP-capable network subscriber can take the place of the controllers A or B.

According to one embodiment, in a universal SNMP agent, the user can define his own sub-regions in the MIB and can then implement the objects in the control program. This means that the user gives an SNMP agent that knows SNMP objects and provides for access to the data of the control program. In this way it is possible for the user to use any SNMP object, self-defined object, or also objects from Standard MIBs. The preceding constructions also apply analogously for the SNMP clients. With the SNMP Client component, the user can access any SNMP object of the other subscriber in the network. The term “universal” means that the user is completely free in the use of the Simple Network Management Protocol. In contrast, known network components do not allow the user to add its own SNMP objects to an SNMP agent of an appropriate device, because the set of SNMP objects is always defined by the manufacturer of the components. Mapping of arbitrary information from the control program onto the SNMP is possible only with additional PC programs.

According to the invention, the SNMP can also be used for monitoring the subscriber or for controlling the subscriber in a network. In addition, information from a control program can be made accessible via the SNMP in the form of data from the process to be controlled. Thus, for example, in a train car, a switch cabinet can be used with a controller that is provided for controlling or regulating temperature, wherein this controller can be accessed from a central location, for example, for reading the car temperature. In this case, the SNMP can be used for direct communications with the controller, for example, from a PC program.

The SNMP can be further used according to the invention to allow direct data exchange between controllers. Here, for example, the controller A transmits an “outside temperature” data set to the controller B that can further process the data. This direct data exchange between controllers cannot be realized via a standard protocol with the known controller communications concepts. The invention thus creates a simple communications platform also beyond network boundaries past routers or firewalls.

For the use of the SNMP according to the invention, all of the known controller fields come into question. For example, the SNMP can be used according to the invention in a conveyor belt with several controllers that exchange data on the transport path or on the goods to be transported, or in the field of building management where controllers report the fill level of rainwater cisterns to the household water system, or in a railway train where controllers in the cars receive the desired temperature settings via the SNMP from a central controller, for example, in the locomotive, or in roadway tunnels where local controllers in the tunnel are activated by a central controller in the control room and, e.g., the air values are queried.

1. Control device comprising:
a supply device (101) for preparing control data for process control; and
a network device (103) for transmitting or receiving the control data using the Simple Network Management Protocol.

2. Control device according to claim 1, wherein the supply device (101) is constructed to transmit the control data to the network device (103) or to receive the control data from the network device.

3. Control device according to claim 1, wherein the network device (103) comprises a program-specific protocol device (105) to be able to execute the Simple Network Management Protocol.

4. Control device according to claim 1, wherein the network device (103) comprises a transmitter (109) and/or a receiver (107) for communicating via a communications network using the Simple Network Management Protocol.

5. Control device according to claim 1, wherein the control data comprise process data, process parameters, or control parameters.

6. Control device according to claim 1, wherein the supply device (101) comprises a memory device for storing the control data in a database.

7. Control device according to claim 1, wherein the control device is constructed to communicate with another control device via a communications network using the Simple Network Management Protocol.

8. Control device according to claim 1, wherein the control device further comprises a server and/or a client for communicating via a communications network using the Simple Network Management Protocol.

9. Control system for controlling a control device, wherein the control device is provided for process control using control data and wherein the control system comprises:
a supply device for preparing the control data; and
a network device for transmitting the control data to the control device via a communications network using the Simple Network Management Protocol.

10. A method for communicating control data between control devices via a communications network. the method comprising utilizing the Simple Network Management Protocol.

11. Control method using control data, the method comprising:
preparing the control data; and
performing one of i) transmitting and ii) receiving the control data using the Simple Network Management Protocol.

12. Control method according to claim 11, in which a technical process is controlled using the control data.

13. Method for controlling a control device, wherein the control device is provided for process control using control data and wherein the method comprises:
preparing the control data; and
transmitting the control data to the control device via a communications network using the Simple Network Management Protocol.

14. Program-specific device constructed to be able to execute a computer program for performing the method according to claim 13.

15. A program storage medium for storing a computer program for performing the method according to claim 13 when the computer program runs on a computer.
